(19) United States
(12) Patent Application Publication
(10) Pub. No.: US 2003/0127998 A1
(43) Pub. Date: Jul. 10, 2003

(54) Lighting depreciation compensation system and method

(75) Inventors: Joseph C. Notarianni, Naples, FL (US); Timothy Yablonowski, Naples, FL (US)

Correspondence Address: Brinks Hofer Gilson & Lione, NBC Tower, Suite 3600, P.O. Box 10395, Chicago, IL, 60610, US

(73) Assignee: Ultrawatt Energy Sysems, Inc.

(21) Appl. No.: 10/041,193

(22) Filed: Jan. 8, 2002

(51) Int. Cl. H05B 41/00

(52) U.S. Cl. 315/312; 315/318

(57) ABSTRACT

Lighting depreciation is compensated by systems and methods. Where a reduction in power is provided to a lamp for saving energy costs, the amount of power reduction is decreased as a function of the age of the lamp. The decrease in power reduction compensates for lighting deprecation of the lamp. The power provided to the lamp is increased as a function of the age of the lamp.

### BACKGROUND

The light output of high intensity discharge lamps decreases over time. The decrease in output is low over any short period of time, so that the changes in output are subtle. Most rooms or warehouses are lit sufficiently that the decrease in light output is not noticed by users of the area. However, the lighting depreciation over the life of a lamp can be substantial. Lighting depreciation is most noticeable by users when old lamps are replaced with new lamps.

### BRIEF SUMMARY

The present invention is defined by the following claims, and nothing in this section should be taken as a limitation on those claims. By way of introduction, the embodiments described below include methods and systems for lighting depreciation compensation. Where a reduction in power is provided to a lamp for saving energy costs, the amount of power reduction is decreased as a function of the age of the lamp. The decrease in power reduction compensates for lighting deprecation of the lamp. The power provided to the lamp is increased as a function of the age of the lamp.

In a first aspect, a method for lighting depreciation compensation is provided. An amount of power output to a lighting lamp load from an AC source is reduced. The amount of power output is altered as a function of the age of the lamp of the lighting load.

In a second aspect, a lighting depreciation compensation system for power savings operation is provided. The system includes a lamp and a lighting control unit connected to the lamp. The lighting control unit is operative to reduce an amount of power output to the lamp and alter the amount of power output as a function of the age of the lamp.

In a third aspect, a light depreciation compensation system for lighting loads is provided. The system includes a user input and a controller connected with the user input. The controller is operable to be connected with a plurality of lights and an AC source. The controller is also operative to increase an amount of power as a function of an age of the lamp. The age information is responsive to information from the user input.

Further aspects and advantages of the invention are discussed below in conjunction with the preferred embodiments.

### BRIEF DESCRIPTION OF SEVERAL VIEWS OF THE DRAWINGS

FIG. 1 is a block diagram of one embodiment of a lighting depreciation compensation system.

FIG. 2 is a flow chart diagram representing one embodiment of a method for compensating for lighting depreciation.

### DETAILED DESCRIPTION OF THE PREFERRED EMBODIMENTS

To account for lighting depreciation due to the age of a lamp, the amount of power or voltage provided to the lamp is increased. The increase in power or voltage causes an aged lamp to output more light or lumens. In one embodiment, the amount of power reduction provided by a power savings unit is decreased to compensate for the age of the lamp. The power savings unit is connected to a single lamp or multiple lamps and also may be connected to a network for overall control of various circuits.

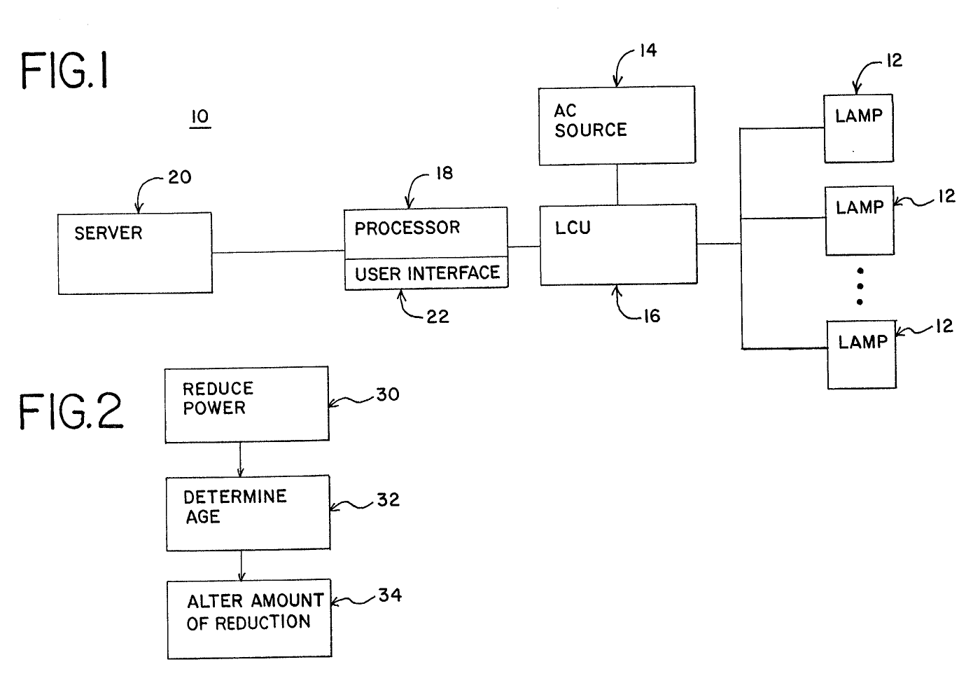

FIG. 1 shows a lighting depreciation compensation system 10. The system 10 includes one or more lamps 12, an alternating current (AC) source 14, a lighting control unit 16, a processor 18 with a user interface 22 and a server 20. Additional, fewer or different components may be used. For example, additional lighting control units 16 are provided. As another example, the system 10 does not include the processor 18 or server 20.

The AC source 14 comprises a source of line voltage, such as provided by a utility, an alternating current generator, breaker box or circuit panel, a source of direct current with a DC to AC converter, or another source. The lamps 12 comprise one or more lighting loads. For example, halogen, incandescent, ballasted fluorescent or ballasted high intensity discharge lighting loads are provided. Magnetically ballasted or electronically ballasted lighting loads or lamps may be used. While multiple lamps 12 are shown, the system 10 may include only one lamp 12. The lamps 12 may comprise single or multiple lighting load devices consisting of a combination of resistive, capacitive and inductive elements. In some embodiments, each lamp 12 comprises a different device, such as different types of lighting loads. For example, a halogen, incandescent and ballasted fluorescent lighting loads are provided as separate lamps 12 on a same circuit. In alternative embodiments, other loads, such as motors or transformers, may be provided.

The lighting control unit 16 comprises a power savings unit or voltage reduction system. For example, the lighting control unit 16 comprises an AC power switch or switches connected in parallel with a capacitor. The power switch and capacitor are connected in series in between the AC source 14 and the lamps 12. Control circuitry operates the switch to reduce the root mean square voltage or power provided to the lamps 12. Examples of such lighting control units are disclosed in U.S. Pat. Nos. 5,583,423; 5,754,036 and 6,172,489, assigned to the assignee of the present invention, the disclosures of which are incorporated herein by reference. In alternative embodiments, autotransformers, Thyristor switch systems, or other power reduction or savings units may be used.

The lighting control unit 16 reduces a power characteristic, such as the root means square voltage or current, provided to the lamps 12. For example, a switch of the lighting control unit 16 is turned off prior to a zero crossing of a half cycle of the AC cycle waveform, passing current through a parallel capacitor. Other switch turn-on and off timings may be used. As another example, a tap location of an autotransformer is changed, altering the peak voltage.

The amount of power reduction is selected as a function of various characteristics, such as a desired power savings, hours of operation, utility arranged curtailment, lighting depreciation compensation, by-pass mode operation and calibration. Additional, different or fewer parameters may be used for determining an amount of power reduction. In one embodiment, a power savings mode associated with 20% or more reduction in power provided to the lamps 12 for saving utility costs or power usage is provided. For example, a user selectable amount of power reduction provides sufficient light while minimizing the current or power used.

The lighting control unit 16 is operable to increase the power provided to the lamps 12 as a function of the age of the lamp. In one embodiment, the amount of power reduction provided by the lighting control unit 16 is decreased as a function of the lamp age, increasing the power provided to the lamps 12. In alternative embodiments, the lighting control unit 16 increases the voltage from the AC source 14 provided to the lamps 12. Altering a power characteristic of the alternating current waveform provided by the AC source 14 changes the power. For example, a root means square voltage or current is altered.

While only one lighting control unit 16 is shown, a plurality of lighting control units 16 connected with one or more AC sources 14 are provided in alternative embodiments. Different lamps 12 or associated circuits are connected to each of the lighting control units 16.

The optional processor 18 comprises a personal computer, a general processor, an application specific integrated circuit, digital signal processor or other processor for controlling the lighting control unit 16. The processor 18 operates using Scada Vision software from United Controls Corporation, but other software may be used. In one embodiment, the processor 18 is included in the lighting control unit 16. In an alternative embodiment, the processor 18 controls multiple lighting control units. For example, the processor 18 electronically connects with lighting control units 16 to over-ride operation of one or more lighting control units 16. As another example, the processor 18 provides control instructions for regular operation of the lighting control units 16. The processor 18 monitors the age of one or more lamps 12 and causes the lighting control unit 16 to increase the amount of power provided to the lamps 12 as the age of the lamps 12 increases. The processor 18 may also control the power savings mode of the lighting control unit 16, such as controlling an amount of power reduction provided with the lighting depreciation compensation.

The optional user interface 22 comprises a keyboard, buttons, trackball, mouse or other input device for configuring operation of the processor 18 or lighting control unit 16. The user interface 22 is electronically connected to the processor 18 or part of the lighting control unit 16. A user inputs various parameters, such as indicating a day in which a new lamp 12 is connected to the lighting control unit 16, an amount of reduction for operation in the power savings mode, a number of days of operation for relamping the lamps 12, a circuit or group of operation designation, curtailment operation parameters for further reducing loads to utilities, a schedule of operation (e.g. days and times in which lights are automatically turned off or on), selection of additional input (e.g. a light sensor associated with the area lit by the lamps 12), or other parameters. The number of lighting control units 16, number of input/output blocks, number of power meters, and grouping of lighting control units 16 and/or lamps 12 for differential operation. The amount of alternation of the power reduction or increase in power as a function of the age of the lamp is also input. For example, an initial power reduction is set at 20%; after 67 days the amount of power reduction is decreased to 17%; after another 67 days, the amount of power reduction is decreased to 15%; . . . . Different time periods and amounts of alterations of the power as a function of age of the lamps may be programmed and varied linearly or non-linearly. Different age functions may be provided for different ranges of power savings or reductions of amount of power provided to the lamps 12. For example, different ranges of power reduction are associated with different levels of a capacitance connected in parallel with a switch. Any of the various parameters may be programmed within the processor 18 or lighting control unit 16 without user input on the user interface 22, such as through communications with the server 20 or programming during manufacture.

The user interface 22 also allows selection or entry of communication information. For example, a phone number mail server URL, mail server user ID, mail server password or other information is programmed into processor 18. The processor 18 in one embodiment includes a communication card or circuit, such as a modem or Ethernet communications card. The communications card allows electrical connection with the server 20 or another processor. For example, the processor sends data over a direct phone link or over a compute network using email-type communications. For an example of a lighting control unit network, associated processor 18 and servers 20, see U.S. Pat. Nos. ______ ______, and ______, (U.S. application Ser. Nos. 09/454,775, filed Dec. 3, 1999 and 09/541,264, filed Apr. 3, 2000), assigned to the assignee of the present invention, the disclosures of which are incorporated herein by reference. The processor 18 sends information regarding operation of the lamps 12 and lighting control units 16 to the server for archiving and analysis. Alarms, such as loss of alternating current, operation bypass or no savings mode, communications failure, fault or lack of operation of the lighting control unit 16, unplugging of the communications link and a general report, are provided to the server 20. Additional, less or different information may be provided. Information is exchanged on a regular basis, such as weekly or daily.

The processor 18 may be remote from one or more of the lighting control unit 16, so an electronic communications link, such as wireless, phone, hard wire or other connection is provided.

The optional server 20 comprises a processor, network server, personal computer, or other device for communicating with one or more processors 18 or lighting control units 16. For example, the server 20 is provided by a lighting system or power system monitoring or control company to operate or manage the loads of various customers. The server 20 provides diagnostic information or control information to the processor 18 or lighting control unit 16.

One or more of the server 20, the processor 18, or lighting control unit 16 comprise a controller for increasing the amount of power provided to the lamps 12 as a function of the age of the lamps 12. In one embodiment, the controller decreases an amount of power reduction as a function of the age of the lamps 12.

FIG. 2 is a flowchart diagram of a method for lighting depreciation compensation. In act 30, a power provided to a lamp is reduced. An age of the lamp is determined in act 32. The amount of reduction of act 30 is altered in act 34 as a function of the age of the lamp. Additional, fewer or different acts may be provided, such as just determining the age of the lamp and increasing the amount of power provided to the lamp as the age increases.

In act 30, the amount of power provided to the lamps 12 is reduced in a power savings mode of operation. One of different levels of power savings are provided. For example, a 30%, 20% or other amount of power savings associated with a reduction in power with a minimal loss of lighting intensity are selected by a user. Greater or lesser percentages may be selected. In one embodiment, the amount of power reduction in the power savings mode is selected as a function of natural light level. A light sensor is provided for detecting the natural light level. With greater amounts of natural light, more power reduction or a greater percentage is used. Ambient light due to sky lights or windows allows for a greater amount of power savings. As ambient light decreases, the power savings is reduced for a greater lighting intensity from the lamps 12.

In act 32, the age of the lamp is determined. The age of the lamp is determined from user input. For example, the day of a relamping of multiple lamps 12 or all the lamps 12 is indicated through the user interface 22 or communicated with the server 20. In alternative embodiments, a new lamp 12 is detected as a function of the lighting output given a particular power input or as a function of a mechanical sensor associated with the lamp socket. The age of the lamp is determined as a function of the number of days or other time since installment of a new lamp 12 or the number of days or hours of operation or use of the lamp 12 since the initial installment of a new lamp 12. Other age calculations, including different time increments and the time to select for calculating the age, may be used.

In act 34, the amount of power provided to the lamp 12 is altered. The power provided to the lamp 12 is increased with the increasing age of the lamp. The amount of power reduction provided in act 30 is decreased. The increase of power as a function of the age of the lamp is less than the reduction of power provided to the lamp in the power savings mode of operation. For example, the power provided to the lamp is reduced by Y%, where Y is equal to 20, 30 or another value. The alteration as a function of the age of the lamp is X%, where X is equal to 1, 2, 3, 4, 5 or another percentage of the amount of power provided to the lamp 12. In the example above, Y is greater than X. In alternate embodiments, X is equal to or greater than Y.

The alteration of act 34 is either linear or non-linear. For example, the amount of alteration is calculated as a linear function of age using a formula. As an example of non-linear alteration, the change in the amount of reduction is performed in steps based on age ranges. Different levels or amounts of alteration in the amount of power reduction as a function of age may also be are provided for different age ranges. At a first time, the amount of power reduction is decreased by a first percentage, such as 2%. At a second time, the amount of power reduction is decreased by an additional percentage, such as an additional 2% or a different percentage. Further reductions or no other reductions may be provided over the remaining life of the lamp 12.

In one embodiment, the lighting depreciation compensation system 10 includes additional hardware and capabilities. A revenue accurate meter is provided for monitoring the power drawn from the utility. Communication power supplies and modules interconnect the various components of the system 10. An uninterrupted power supply for operation of the system 10 during an interruption in power from the AC source 14 is provided. Various wiring harnesses and jumpers for interconnecting the components are also provided. The processor 18 and/or the lighting control unit 16 are adapted for mounting to a wall or desk.

The system 10 of this further embodiment is an automatic lighting management system using the ScadaVision software (e.g. both client and server versions) discussed above. Various lighting control units 16 are grouped to function in dissimilar ways. Within a grouping of lighting control units 16, additional areas of differentiated control may be provided for fine-tuning particular circuits. Various functions and features are available for each grouping or area within a grouping, such as the hours of operation, switching between different power savings levels based on occupancy (e.g. using motion sensors to determine when someone is in the room to decrease the amount of power savings), automatic switching between power savings level as a function of the time of day, curtailment for allowing power reduction to be increased to a greater savings level or shut off for utility curtailment programs, altering the amount of power savings as a function of the ambient light, lighting depreciation compensation, by-pass operation for normal full power operation and calibration operation for verifying power savings. Fewer, different or additional features may be provided. The features are the same or different as a function of the group or area within a group of lighting control unit 16.

In this embodiment, a monitoring system comprising three servers 20 is used, but more or fewer servers may be provided. The servers 20 connect with multiple customers. A mail server receives alarms from each customer, another server monitors the mail server, constructs the database or archived information and routes alarms to an alarm server. The alarm server receives the alarms and historical power measurement information to construct a redundant database. Using the various servers 20, the system 10 is controlled remotely, and audio or visual alerts are provided for each customer at a central location. Maintenance personnel are dispatched immediately after an alarm is received or scheduled as a function of alarms for more immediate repair of lighting at the appropriate customer. Other network configurations and modes of operation may be provided.

While the invention has been described above by reference to various embodiments, it will be understood that many changes and modifications can be made without departing from the spirit and scope of the invention. For example, different types of lighting control units may be provided with or without further network connectivity. As another example, the lighting control unit may control only a single lamp or a plurality of different lamps. As yet another example, differences in operations of non-lighting loads as a function of age may be compensated for using a controller as discussed above.

It is therefore intended that the foregoing detailed description be understood as an illustration of the presently preferred embodiments of the invention, and not as a definition of the invention. It is only the following claims, including all equivalents, that are intended to define the scope of this invention.

What is claimed is:

1. A method for lighting depreciation compensation, the method comprising:
(a) reducing an amount of power output to a lighting lamp load from an AC source; and
(b) altering the amount of power output as a function of an age of a lamp of the lighting lamp load.

2. The method of claim 1 wherein (a) comprises reducing an amount of power output to a plurality of high intensity discharge lamps.

3. The method of claim 1 wherein (a) comprises operating a power savings unit in a power savings mode.

4. The method of claim 1 wherein (b) comprises increasing the amount of power as a function of the age.

5. The method of claim 4 wherein (a) comprises reducing the amount of power output by X% and (b) comprises increasing the amount of power by Y% as a function of the age, where Y is less than X.

6. The method of claim 5 wherein Y is 20 or more and X is 5 or less.

7. The method of claim 4 wherein (b) comprises increasing the amount of power as a function of the age a first time; and
further comprising:
(c) increasing the amount of power as a function of the age a second time, the second time after the first time.

8. The method of claim 1 wherein (b) comprises altering as a function of a number of days of operation of the lamp.

9. The method of claim 1 wherein (b) comprises altering as a function of the age and as a function of the amount of power output in (a).

10. The method of claim 1 further comprising:
(c) controlling (a) and (b) for a plurality of lighting control units with a central processor electrically connected with each of the lighting control units.

11. A lighting depreciation compensation system for power savings operation, the system comprising:
a lamp; and
a lighting control unit connected with the lamp, the lighting control unit operative to reduce an amount of power output to the lamp and alter the amount of power output as a function of an age of the lamp.

12. The system of claim 11 wherein the lamp comprises a high intensity discharge lamp and further comprising a plurality of high intensity discharge lamps connected with the lighting control unit.

13. The system of claim 11 wherein the lighting control unit is operable in a power savings mode associated with the reduction of the amount of power output to the lamp.

14. The system of claim 11 wherein the lighting control unit is operable to decreasing the amount of power output reduction as a function of the age.

15. The system of claim 14 wherein the lighting control unit is operable to reducing the amount of power output by X% and increasing the amount of power by Y% as a function of the age, where Y is less than X.

16. The system of claim 11 wherein the lighting control unit comprises a switch and capacitance connected in series between an AC source and the lamp.

17. The system of claim 11 further comprising a processor operable to monitor the age and control the lighting control unit as a function of the age.

18. The system of claim 17 wherein the processor is operable to send e-mails about operation of the lighting control unit.

19. A lighting depreciation compensation system for lighting loads, the system comprising:
a user input; and
a controller connected with the user input, the controller operable to be connected with a plurality of lights and an AC source, the controller operative to increase an amount of power as a function of an age of the lamp, the age responsive to information from the user input.

20. The system of claim 19 wherein the controller comprises a power reduction device operable to reduce power provided to the plurality of lights from the AC source in a power savings mode, the increase in the amount of power being less than the reduction in power associated with the power savings mode.
